(19) United States
(12) Patent Application Publication
(10) Pub. No.: US 2005/0052327 A1
(43) Pub. Date: Mar. 10, 2005

(54) Folded antenna

(76) Inventor: Jerry C. Posluszny, La Grange Park, IL (US)

Correspondence Address: George H. Gerstman;SEYFARTH SHAW, 55 East Monroe Street, Chicago, IL, 60603, US

(21) Appl. No.: 10/659,658

(22) Filed: Sep. 10, 2003

(51) Int. Cl. H01Q 9/00

(52) U.S. Cl. 343/745

(57) ABSTRACT

A folded monopole antenna is provided. The antenna comprises a tube formed of an electrically conductive material having a dielectric therewithin. An electrically conductive wire extends through the dielectric coaxially with the tube. The electrically conductive wire is electrically connected to the tube at one end of the tube. In one embodiment, the electrically conductive wire is connected to the tube by means of an electrically conductive disc which provides capacitive loading. The feed point of the antenna is coupled to the tube at an end of the tube that is opposite to the end at which the wire is electrically connected to the tube. In another embodiment, a folded dipole antenna is provided comprising a pair of separate coaxially aligned tubes formed of an electrically conductive material, each carrying a dielectric therewithin. An electrically conductive wire extends through the dielectric and coaxially with said coaxially aligned tubes, with the electrically conductive wire being electrically connected to the tubes at opposite ends thereof.

### FIELD OF THE INVENTION

The present invention concerns a novel folded antenna and, more particularly, a novel folded monopole type antenna and a novel folded dipole type antenna.

### BACKGROUND OF THE INVENTION

In a standard folded monopole the antenna element is comprised of two closely spaced parallel vertical wires connected at the top. The pair of wires are ¼ wavelength long at the design frequency. One of the vertical wires is fed with RF at the bottom, the other vertical wire is connected to ground. The antenna is made to work against a ground plane, or a radial wire counterpoise. The advantage of this type of antenna over a single wire vertical monopole is firstly the antenna element is at ground potential. Secondly the input impedance of the antenna can be varied by changing the spacing of the parallel wires and the ratio of the two wire diameters.

I have discovered a novel antenna that is constructed in a manner to provide a compact, but rigid assembly, having a broad band and the ability to go to a relatively high frequency with dependability.

### SUMMARY OF THE INVENTION

In accordance with one embodiment of the present invention, a folded monopole antenna is provided. The folded monopole antenna comprises a tube formed of an electrically conductive material with a dielectric within the tube. An electrically conductive wire extends through the dielectric, coaxially with the tube. The wire is electrically connected to the tube at one end of the tube.

In one embodiment, the wire is electrically connected to the tube by means of electrical wire. In another embodiment, the wire is connected to the tube by means of an electrically conductive disc which provides capacitive loading.

In one embodiment, the feed point of the antenna is coupled to the tube at the end of the tube opposite to the end to which the electrically conductive wire is electrically connected to the tube.

In one embodiment, the antenna is formed from a coaxial cable.

In one embodiment of the invention, a coaxial folded dipole is provided comprising two coaxial folded elements. The coaxial folded dipole comprises two tubes aligned end to end with a gap between them.

A more detailed explanation of the invention is provided in the following description and claims, and is illustrated in the accompanying drawings.

### BRIEF DESCRIPTION OF THE DRAWINGS

FIG. 1 is a diagrammatic view of a standard folded monopole in the prior art.

FIG. 2 is a diagrammatic view of a coaxial folded monopole constructed in accordance with the principles of the present invention.

FIG. 3 is a diagrammatic view of a coaxial folded monopole with capacitive loading constructed in accordance with the principles of the present invention.

FIG. 4 is a diagrammatic view of a coaxial folded dipole in accordance with the principles of the present invention.

FIG. 5 is a cross-sectional elevation of a coaxial folded monopole constructed in accordance with the principles of the present invention.

FIG. 6 is a cross-sectional elevation of a coaxial folded monopole with capacitive loading, constructed in accordance with the principles of the present invention.

### DETAILED DESCRIPTION OF THE INVENTION

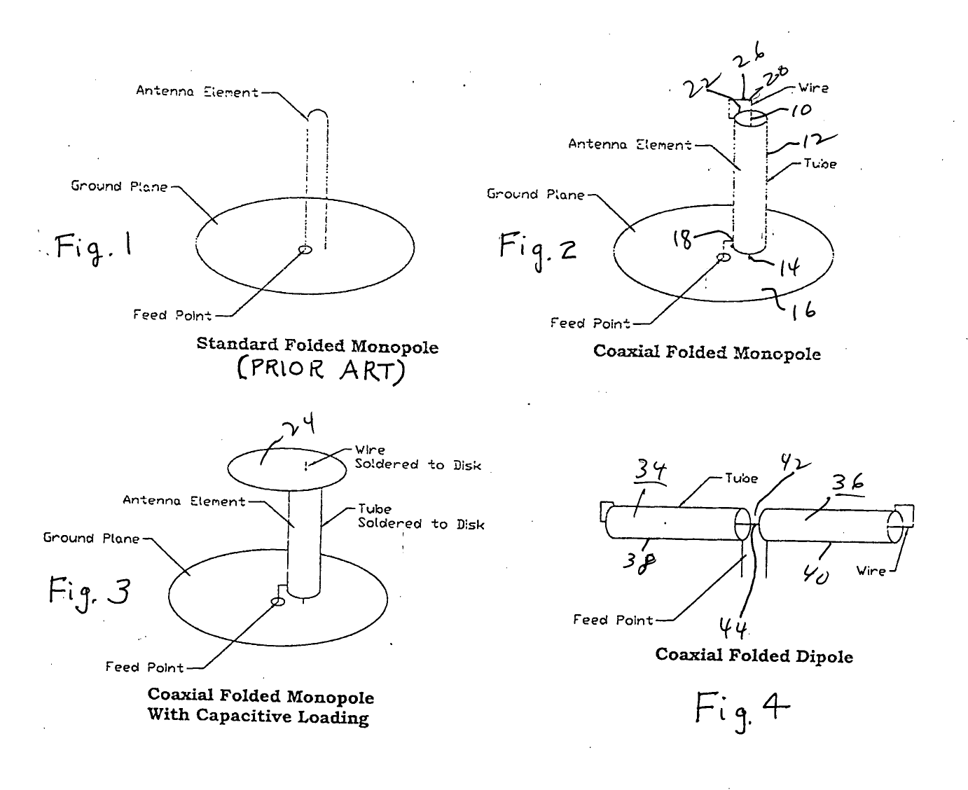

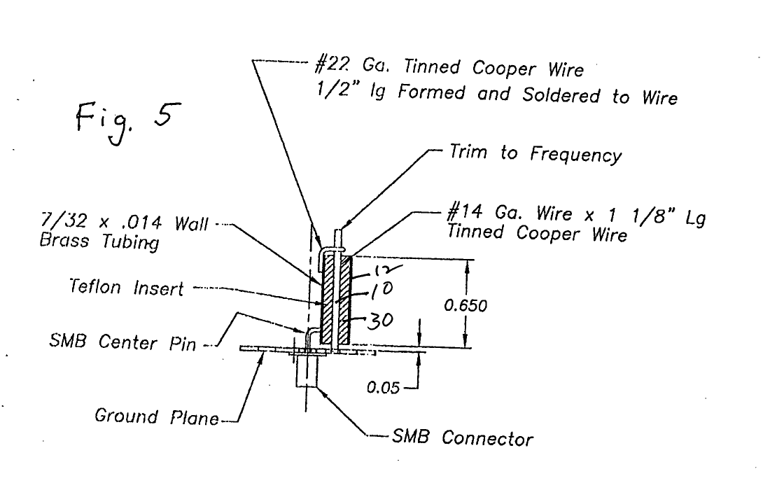

A coaxial folded monopole antenna is illustrated in FIGS. 2, 3, 5 and 6. The two parallel wires of the standard prior art folded monopole are replaced with a thin single vertical wire 10 with a larger concentric tube 12 or sleeve around it. The single wire 10 is connected at the bottom 14 to ground 16 and the RF is fed at the bottom of the tube 18. The top end 20 of the wire and the top end 22 of the tube are connected together by a small disc 24 (FIG. 3) or wire 26 (FIG. 2). The ratio of the outside diameter of the single wire 10 and the inside diameter of the tube 12 determines the input impedance of the antenna. The impedance of the antenna section can also be changed by adding an insulation material between the wire 10 and tube 12. The dielectric constant of the insulation material will effect the impedance and also the electrical length of the antenna. Using a high dielectric constant material may result in a antenna which is shorter than ¼ wavelength.

One of the main advantages of the coaxial folded monopole is that it allows for a more rigid assembly in that it has a large diameter along the outside of the antenna. Further, the space between the inside of the tube and the outside of the wire is filled with a plastic material or dielectric, resulting in an electrical shortening of the antenna due to the dielectric constant of the dielectric material. The dielectric material could be ceramic or plastic, etc. For a given ¼ wave antenna, the mechanical length of the device advantageously becomes shorter. Also, due to the dielectric material, there is a broadbanding effect.

The wire 10 and tube 12 in effect make a piece of coaxial cable which is shorted at one end. The wire 10 and tube 12 can be replaced with an appropriate length of commercial coaxial cable feed line.

The antenna can be shortened further by adding a capacitance to the top. For instance, at the point where the wire and tube are connected, a disc 24 of a large diameter can be use to add top loading.

In certain antenna applications the antenna must be able to provide a high current path to ground from the antenna element. A benefit of this design is the diameter of the center wire may be chosen first so that it can handle the current flow.

Another advantage is that by making the antenna like a standard coaxial cable, a much higher frequency is achieved with dependability. In the standard folded monopole, the two pieces of wire bent into a hair pin are self limiting on the top end of the frequency. However, by providing a coaxial assembly as in the present invention, the upper frequency is almost unlimited and can be taken well up into the mid gigahertz range.

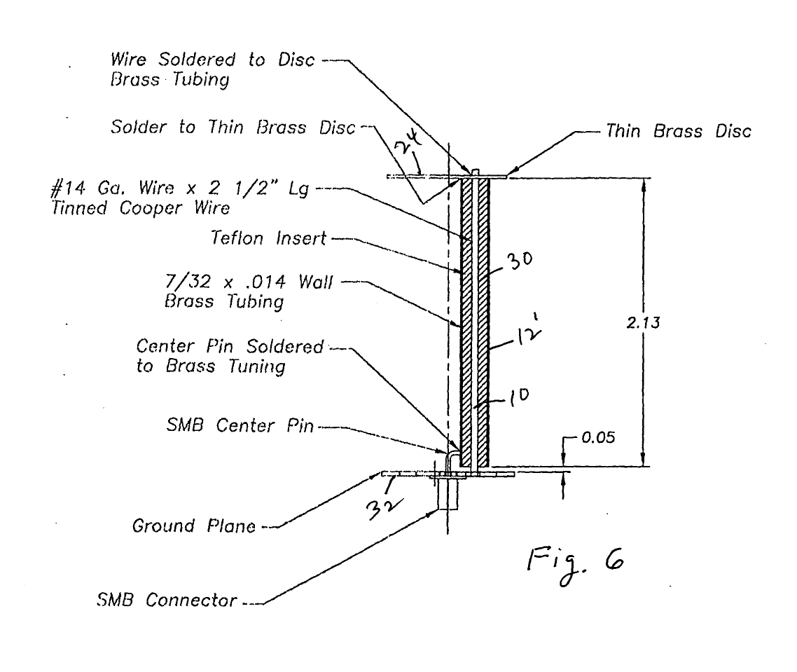

In a specific example although no limitation is intended, referring to FIG. 5, the tube of the coaxial folded monopole antenna is 0.65 inch long and formed of brass, 7/32nds of an inch in diameter. The wire is approximately 0.050 inch diameter and a Teflon dielectric 30 is used in the tube 12 through which the wire 10 extends. The center wire 10 that comes out of the top is extended above the top of the tube 12 to enable the frequency to be adjusted by cutting a portion off the top of the wire 10 to provide a desired operating frequency of approximately 2.4 GHz. The resulting wire extends approximately ⅛ of an inch above the top of the brass tube. It is preferred that the wire 10 originally be approximately ½ inch above the top of the tube so that it is available for trimming to the desired frequency. A coaxial folded monopole works in approximately the 50-75 ohms range, while a prior art folded monopole normally works in a 150-300 ohms range.

In another specific example although no limitation is intended, the embodiment of FIG. 6 uses capacitive loading, the brass tube 12′ is 2.13 inches long and 7/32nds of an inch in diameter. The capacitive disc is approximately 1 inch in diameter and the resonance of the antenna is in the cellular band at approximately 850 MHz. The capacitive disc 24 is formed of 0.020 inch thick brass. The Teflon dielectric 30 that is used inside the tube 12′ gives some electric shortening but adding the large disc 24 on the top primarily provides capacitive loading, allowing the length of the tube to be shortened even greater. Thus, the tube 12 contains a plastic insulator 30 inside the tube with the wire 10 extending through the tube and up to the disc 24 which is soldered to the top of the tube 12, with the wire 10 extending through a hole in the disc. Although the wire can be flush with the top of the disc, it could extend through the disc and above the disc in order to be used for trimming the frequency.

The bottom of the wire 10 is connected to a ground plane 32.

In an alternative embodiment, a coaxial folded dipole type antenna is provided, as illustrated in FIG. 4. The coaxial folded dipole type antenna is made with two coaxial folded elements 34 and 36. The configuration would be two tubes 38 and 40 aligned end-to-end with a small gap 42 between them. A single wire 44 would go through both tubes and be connected to the outside ends of the tubes. This would be a ½ wavelength dipole and not need a ground or counterpoise to operate correctly. The feed would be a balanced type feed across the gap of the tubes. Both dielectric and capacitive loading could be used to shorten the length of the dipole as in the coaxial folded monopole design.

Using the principles of the present invention, an antenna is provided having a broader bandwidth and resonance because of the impedance matching capabilities of the coaxial configuration. Further, utilizing the coaxial configuration also enables the antenna to operate more consistently at higher frequencies, up to 3.5 GHz and possibly higher.

Using the principles of the invention, the wire and tube could be formed by a coaxial cable, with the center conductor forming the wire described above, the braiding forming the tube and the dielectric of the coaxial cable forming the dielectric of the antenna. In the coaxial folded monopole antenna, the central conductor or wire is shorted to the braid at one end of the antenna and the feed point is electrically coupled to the braid at the opposite end of the antenna.

Although illustrative embodiments of the invention have been shown and described, it is to be understood that various modifications and substitutions may be made by those skilled in the art without departing from the novel spirit and scope of the present invention.

1. A folded monopole antenna which comprises:
a tube formed of electrically conductive material;
a dielectric within said tube;
an electrically conductive wire extending through said dielectric and coaxially with said tube;
said wire being electrically connected to said tube at one end of said tube.

2. An antenna as defined in claim 1, in which said wire is electrically connected to said tube by means of electrical wire.

3. An antenna as defined in claim 1, in which said wire is connected to said tube by means of an electrically conductive disc which provides capacitive loading.

4. An antenna as defined in claim 1, in which the feed point of the antenna is coupled to the tube at an end of said tube opposite to the end at which said wire is electrically connected to said tube.

5. An antenna as defined in claim 1, in which said antenna is formed from a coaxial cable.

6. A folded monopole antenna, which comprises:
a tube formed of electronically conductive material having a dielectric therewithin;
an electrically conductive wire extending through said dielectric and coaxially with said tube;
said electrically conductive wire being electrically connected to said tube at one end thereof;
the end of said tube opposite to said one end being connected to a ground plane; and
an antenna feed point being coupled to said opposite end of said tube.

7. An antenna as defined in claim 6, in which said electrical wire comprises a trimming wire extending past said one end.

8. A folded dipole antenna, which comprises:
a first tube formed of electrically conductive material having a dielectric therewithin;
a second tube formed of electrically conductive material having a dielectric therewithin, said first and second tubes being aligned coaxially;
an electrically conductive wire extending through said first and second coaxially aligned tubes, said electrically conductive wire being coaxial with said coaxially aligned tubes;
said first tube and second tube being spaced from each other; and
said electrically conductive wire being electrically connected to opposite ends of said coaxially aligned tubes.
